(19) United States
(12) Patent Application Publication
(10) Pub. No.: US 2015/0101147 A1
(43) Pub. Date: Apr. 16, 2015

(54) Unidirectional Centrifugal Mechanism of Door Operator

(71) Applicant: CHUNG-HSIEN HSIEH, New Taipei City (TW)

(72) Inventor: CHUNG-HSIEN HSIEH, New Taipei City (TW)

(21) Appl. No.: 14/512,549

(22) Filed: Oct. 13, 2014

(30) Foreign Application Priority Data
Oct. 14, 2013 (TW) 102136904

(51) Int. Cl. E05F 3/16

(52) U.S. Cl. CPC E05F 3/16
USPC 16/64

(57) ABSTRACT

A rolling door operator comprises a rotary shaft, a centrifugal brake mechanism, and a unidirectional centrifugal mechanism, in which a latching tooth and plurality of slots are disposed around one end of the rotary shaft, and the unidirectional centrifugal mechanism includes an active pin with an axial latching face and a sliding face, the axial latching face being engaged with one of slots to latch the rotary shaft together only in the falling direction of a door curtain, and the sliding face having a bevel adjacent to the latching face to contact slidingly over the slots, so that the door curtain can be lifted up immediately in another direction, and without affecting normal opening function of the door curtain.

### BACKGROUND OF THE INVENTION

1. Field of the Invention

The invention relates to a unidirectional centrifugal mechanism, and particularly, to a unidirectional centrifugal mechanism of a door operator for a fireproof rolling door, making the rolling door having the functions of fireproof, smoke prevention, and escape.

2. Description of the Related Art

For a general fireproof and smoke prevention rolling door driven vertically or horizontally, a door curtain of slats slides down to close a door with its own weight, so as to effectively block smoke or flame generated during a fire accident. It can⁻be understood that the weight of a rolling door curtain, especially, a large-sized rolling door curtain, is quite heavy, and hence in case it loses control in speed, its dropping due to acceleration of gravity, must cause a destructive power.

As such, an industry manufacturer is always demanded of a strict design for safety, to guarantee that, no matter the door curtain rises or falls, any dangers caused by human factors or machine factors should not happen. Accordingly, a door operator for a general fireproof rolling door is basically provided with a “centrifugal brake mechanism”. Thus, when a fire accident occurs and the door curtain slides down automatically to close the door by its own weight, the falling speed of the rolling door for fireproof and smoke prevention is controlled within a predetermined safety range.

For an emergency exit rolling door and an escape rolling door, they are exactly opposite to each other in structure according to their different functions and purposes. However, In case of a fire accident, they must be kept unblocked and easily opened. Therefore, for a manufacturer, many different controlling types of door operators must be developed in order to response to the requirements for different installation sites, functions and purposes. Accordingly, not only development time is long and cost for the development is high, but also the number of parts is large, which renders production complicated, and inventory cost relatively increased.

It is known that many documents are related to door operators for fireproof rolling doors. For example, U.S. Pat. No. 5,203,392 and U.S. Pat. No. 5,386,891 are proposed. For the disclosure of the above-mentioned patent publications, in the case of no braking during a power outage, the door curtain of slats slides down to close up door by its own weight so as to effectively block smoke or flame generated by a fire accident. On the other hand, if the door curtain of slats must be opened in an emergency for an escape during a fire accident, although the door curtain of slats can be driven to move up by a manual pull-chain mechanism, it takes a lot of time and consumes much more physical strength, and causing a late escape.

Although the manual pull-chain mechanism is used to open the door curtain of slats, a person having ordinary skills in the art is ready to understand that the centrifugal brake mechanism of a traditional door curtain of slats can not only be used to retard the falling speed of the fireproof rolling door or the smoke prevention rolling door, but also can retard the rolling door opening, which resulting in a late door opening.

The inventor thinks that if a centrifugal brake mechanism of door operator retards the falling speed of the door curtain of slats only in one directions but doesn't effect normal opening thereof in the other direction in spite of the case of emergency, then the door operator can be used for the purposes of fireproof, smoke prevention, and escape all together, that is to say, the structure of the door operator and its production are simplified to relatively reduce development and inventory costs thereof.

### SUMMARY OF THE INVENTION

The main objective of the present invention is to provide a unidirectional centrifugal mechanism of a manual door operator for a fireproof and smoke prevention rolling door, wherein when a door curtain slides down to close by its own weight during a fire accident, the falling speed of the door curtain can be unidirectionally retarded within a predetermined safety range by a centrifugal brake mechanism.

Another objective of the present invention is to provide an unidirectional centrifugal mechanism of a manual door operator for a fireproof and smoke prevention door, wherein when a door curtain is closed during a fire accident, the door curtain can be lifted fast to open to escape.

Still another objective of the prevention is to provide an unidirectional centrifugal mechanism of a manual door operator for a fireproof and smoke prevention door, wherein the door operator has the functions of fireproof, smoke prevention, and escape, and thereby the structure of the door operator and its production are simplified, to relatively reduce development and inventory costs thereof.

In order to obtain the above-mentioned objectives and other objectives, an unidirectional centrifugal mechanism of a manual door operator for a fireproof and smoke prevention door according to the prevent invention is provided. The door operator comprises a rotary shaft, a centrifugal brake mechanism, and an unidirectional centrifugal mechanism, wherein the rotary shaft is provided in a housing, a plurality of slots equally spaced from each other are disposed circumferentially on a first end of the rotary shaft, and a second end of the rotary shaft is coupled to an output shaft; the centrifugal brake mechanism includes an end disc, a pair of stationary pins, and a pair of brake pads, wherein the end disc is rotatably mounted on the first end of the rotary shaft, and a shaft hub having a radial mounting hole extends from one end face of the end disc toward the plurality of slots; the pair of stationary pins is disposed on the other end face of the end disc; each of the pair of brake pads has a first end pivoted on one of the pair of stationary pins, and a second end, which is free to swing to urge against an inner wall of the housing when it subjects to a centrifugal force so as to retard the rotating speed of the rotary shaft; the unidirectional centrifugal mechanism includes an active pin, having a unidirectional latching tooth at one end thereof, the active pin being inserted into the mounting hole, the active pin being biased by an elastic element, so that the latching tooth is biased toward the plurality of slots.

According to the unidirectional centrifugal mechanism of the present invention, a base is further included, the base being disposed on the shaft hub and located outside the mounting hole, wherein one end of the active pin is slidably mounted in the mounting hole, and the other end of the active pin extends through the base, with a effect that the elastic element is accommodated in the mounting hole to be compressed and configured to surround the active pin, and is located between the latching tooth and base to make the latching tooth slide toward the plurality of slots constantly.

The latching tooth of the active pin has an axial latching face and a radial sliding face adjacent to the latching face; the plurality of slots of the rotary shaft each includes two oppositely facing slot walls, wherein when one of the two slot walls urges against the latching face, the end disc is driven, and when the other of the two slot walls urges against the sliding face, the end disc is not driven.

Furthermore, the active pin further comprises a draw bar at one other end thereof, and the base includes a limiting slot for receiving the draw bar, so that the heading direction of the latching tooth can be changed, when the draw bar is lifted to disengage from the limiting slot.

Accordingly, with the unidirectional centrifugal mechanism, the centrifugal brake mechanism of the door operator will retard the falling speed of the door curtain only in unidirection, and the door curtain is free to be reversely lifted up to open. That is, the door curtain has the functions of fireproof, smoke prevention, and escape all together, which makes the structure of the door curtain and its production be simplified, and development and inventory costs thereof is relatively reduced.

### BRIEF DESCRIPTION OF THE DRAWINGS

FIG. 1 is an exploded perspective view showing an unidirectional centrifugal mechanism of a door operator of the present invention;

FIG. 2 is a schematic cross-sectional view showing the unidirectional centrifugal mechanism of the door operator of FIG. 1 to be in an assembled state;

FIG. 3 is a schematic cross-sectional view taken along line 3-3 of FIG. 2;

FIG. 4 is a partially enlarged view showing the unidirectional centrifugal mechanism of FIG. 3 with other mechanisms already to be driven by a rotary shaft, in which the other mechanisms, which is irrelevant to description, is omitted;

FIG. 4a is a schematic view showing the unidirectional centrifugal mechanism of FIG. 4 to be not driven by the rotary shaft in a reverse direction to that of FIG. 4;

FIG. 5 is a schematic view showing the unidirectional centrifugal mechanism of FIG. 4 to be driven by the rotary shaft in a reverse direction to that of FIG. 4;

FIG. 5a is a schematic view showing the unidirectional centrifugal mechanism of FIG. 5 to be not driven by the rotary shaft.

### DESCRIPTION OF THE PREFERRED EMBODIMENTS

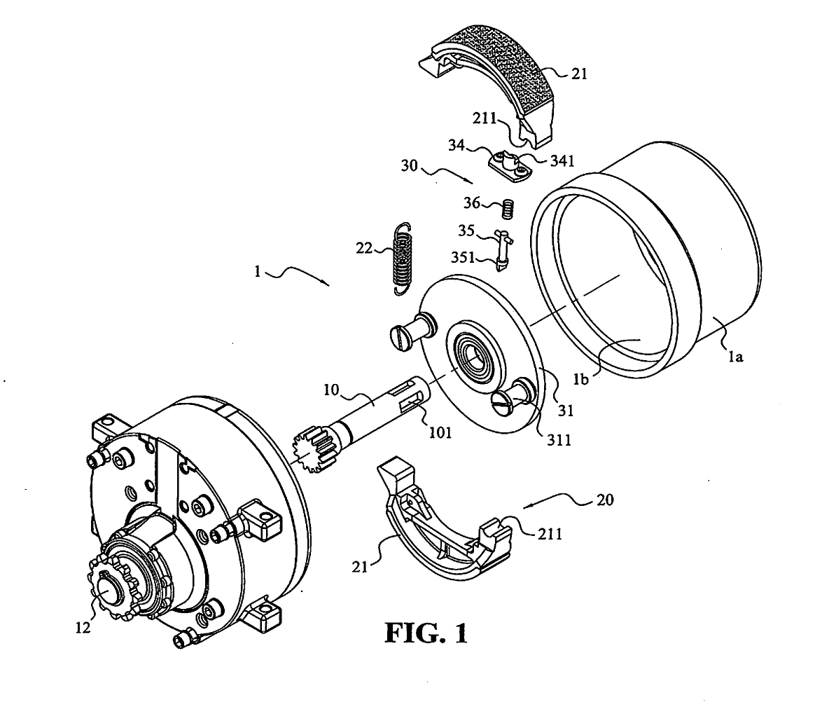

First, a preferred embodiment of a unidirectional centrifugal mechanism of a door operator of the present invention is described with reference to FIGS. 1 to 3. In the embodiment, the door operator is used, for example, for a small-sized manual fireproof and smoke prevention rolling door. As shown in the drawings, the door operator 1 basically comprises a rotary shaft 10, a centrifugal brake mechanism 20, and a unidirectional centrifugal mechanism 30. The rotary shaft 10 is borne by a housing 1a. A plurality of slots 101 equally spaced from each other are disposed circumferentially on a first end of the rotary shaft 10, and a second end of the rotary shaft 10 is coupled to an output shaft 12 via a reduction mechanism (not shown in FIGS. 1 to 3).

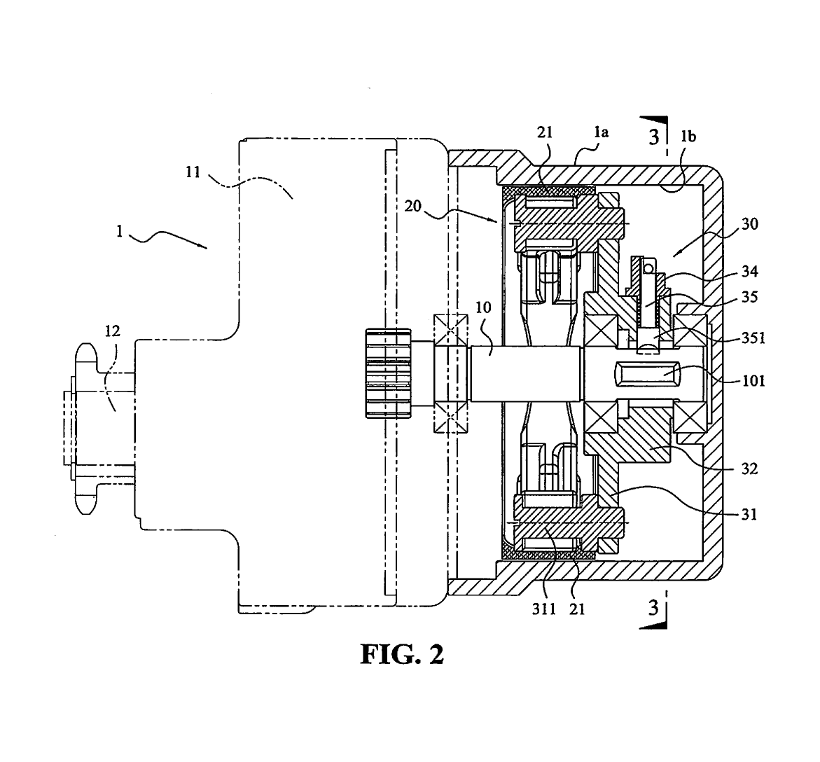

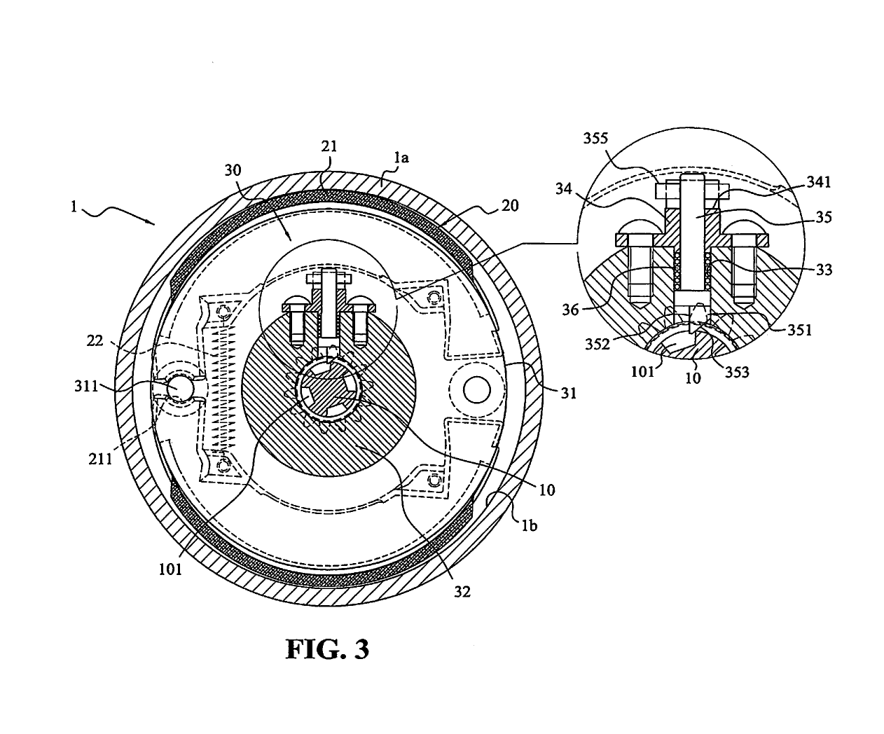

The centrifugal brake mechanism 20 comprises an end disc 31, a pair of stationary pins 311, and a pair of brake pads 21, in which the end disc 31 is rotatably fitted on the first end of the rotary shaft 10, and a shaft hub 32 is provided on the right end face of the end disc 31 to surround the plurality of slots 101, the shaft hub 32 having a radialy-through mounting hole 33. The pair of stationary pins 311 is disposed on the left end face of the end disc 31 opposite to each other. The pair of brake pads 21 is configured to surround the rotary shaft 10 between the first end and second end of the rotary shaft 10. First ends of the brake pads 21 are formed with semi-pivoting rests 211 respectively, and are pivoted on one of the stationary pins 311 with an elastic element 22 holding the brake pads 21 together. The second ends of the brake pads 21 are free to swing to urge against an inner wall 1b of the housing 1a when they subject to centrifugal force (as shown in FIGS. 2 and 3).

The unidirectional centrifugal mechanism 30 comprises a base 34, an active pin 35, and an elastic element 36. The base 34 is located outside the mounting hole 33 and disposed on the shaft hub 32. The active pin 35 is inserted into and slidably mounted within the mounting hole 33. The front end of the active pin 35 is provided with a latching tooth 351, and the rear end of the active pin 35 extends out of the base 34. An elastic element 36 is accommodated in the mounting hole 33 and is located and compressed between the latching tooth 351 and base 34 so as to urge the active pin 35, such that the latching tooth 351 is biased toward the slots 101.

The latching tooth 351 of the active pin 35 has an axial latching face 352 in a vertical direction and a radial sliding face 353 with a bevel adjacent to the latching face 352. Additionally, the active pin 35 is provided with a draw bar at the rear end thereof, and the base 34 is sloted with a horizontal limiting slot 341 for receiving the draw bar, and hence, the heading. direction of the latching tooth 351 can be changed when the draw bar is lifted up to release its disengagement with the 101.

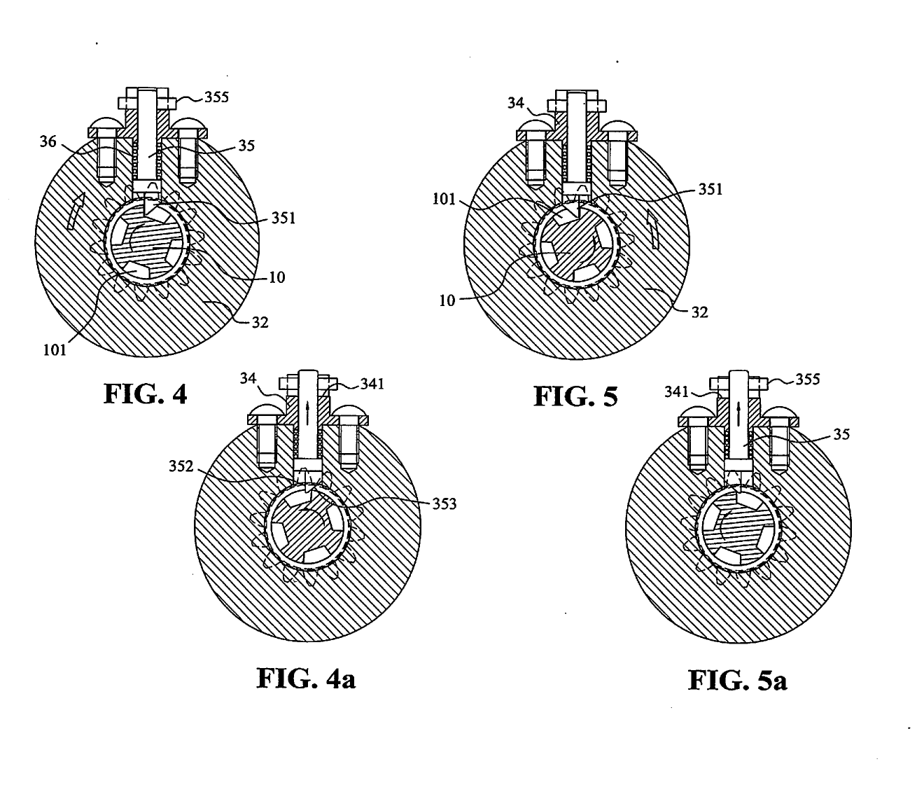

As shown in FIG. 4, when the rotary shaft 10 rotates clockwise, a forward slot wall of the slot 101 will engage with the latching face 352 of the latching tooth 351 to drive the end disc 31, i.e., the centrifugal brake mechanism 20 is rotated accordingly. At this point, the free ends of the brake pads 21 swings outwards around the pin to press against the inner wall 1b of the housing 1a under an induced centrifugal force action. Hence, a friction occurs to retard the speed of rotation of the rotary shaft 10 within a predetermined safety range.

On the contrary, as shown in FIG. 4, when the rotary shaft 10 rotates counterclockwise, a backward slot wall of the slot 101 will contact with the sliding face 353 of the latching tooth 351 and push the sliding face 353 along the bevel thereof to lift up. At this point, the rotary shaft 10 rotates solely, and the end disc 31 is not driven, i.e., the centrifugal force is not exerted on the brake pads 21 of the centrifugal brake mechanism 20.

Moreover, as shown in FIGS. 5 and 5a, the active pin 35 can be lifted from its still position by pulling up the draw bar 355. After the active pin 35 is lifted up and disengaged with the limiting slot 341, the heading direction of the latching tooth 351 can be selectively changed by turning the active pin 35, and then release the draw bar 355. At this point, when the rotary shaft 10 rotates counterclockwise, its speed of rotation is retarded by the brake pads 21 of the centrifugal brake mechanism 20, but when the rotary shaft 10 rotates clockwise, it can rotate freely, which is like the operations of FIGS. 4 and 4a but in inverted sequence.

Accordingly, with the unidirectional centrifugal mechanism, the centrifugal brake mechanism of the door operator can retard the falling speed of the curtain of the door slats only in one direction, but lets the curtain of the door slats alone for it to be easily lifted by manual operation in the other direction without effecting normal opening in spite of the case of emergency, so as to make the door curtain have the functions of fireproof, smoke prevention, and escape all together, which makes the structure of the door operator and its production be simplified to relatively reduce development and inventory costs thereof.

The above embodiment of the present invention is a explanatory example only, and the present invention is not limited to the details disclosed in the drawings and specification. Persons having ordinary skills in the art can make various changes, which should fall within the scope of the present invention, without departing from the scope of the claims.

What is claimed is:

1. A unidirectional centrifugal mechanism of a door operator, the door operator comprising a rotary shaft, a centrifugal brake mechanism, and a unidirectional centrifugal mechanism, wherein:
the rotary shaft is provided in a housing, a plurality of slots equally spaced from each other are disposed circumferentially on a first end of the rotary shaft, and a second end of the rotary shaft is coupled to an output shaft;
the centrifugal brake mechanism includes an end disc, a pair of stationary pins, and a pair of brake pads, wherein the end disc is rotatably mounted on the first end of the rotary shaft, a shaft hub having a radial mounting hole extends from one end face of the end disc toward the plurality of slots; the pair of stationary pins is disposed on the other end face of the end disc; each of the pair of brake pads has a first end pivoted on one of the pair of stationary pins, and a second end, which is free to swing to urge against an inner wall of the housing when it subjects to a centrifugal force so as to retard the rotation speed of the rotary shaft;
the unidirectional centrifugal mechanism includes an active pin having a unidirectional latching tooth at one end thereof, the active pin being inserted into the mounting hole, the active pin being biased by an elastic element, so that the latching tooth is biased toward the plurality of slots.

2. The unidirectional centrifugal mechanism of a door operator as claimed in claim 1, wherein the door operator further comprises a base, disposed on the shaft hub and located outside the mounting hole, one end of the active pine is slidably mounted in the mounting hole, the other end of the active pin extends through the base; the elastic element is accommodated in the mounting hole and is compressed and configured to surround the active pin and is located between the latching tooth and the base.

3. The unidirectional centrifugal mechanism of a door operator as claimed in claim 1, wherein the latching tooth of the active pin has an axial latching face and a radial sliding face adjacent to the latching face; each of the plurality of slots of the rotary shaft includes two oppositely facing slot walls, when one of the two slot walls urges against the latching face, the end disc is driven, but when the other of the two slot walls urges against the sliding face, the end disc is not driven.

4. The unidirectional centrifugal mechanism of a door operator as claimed in claim 2, wherein the active pin further comprises a draw bar at one other end thereof, the base includes a limiting slot for receiving the draw bar, the heading direction of the latching tooth is changed when the draw bar is lifted to disengage from the limiting slot.
